(19) United States
(12) Patent Application Publication
(10) Pub. No.: US 2011/0236208 A1
(43) Pub. Date: Sep. 29, 2011

(54) ROTARY WING BLADE, A ROTARY WING INCLUDING SUCH A BLADE, AND AN AIRCRAFT

(75) Inventors: Jean-Francois Hirsch, Aix En Provence (FR); Jacques Gaffiero, Paris (FR)

(73) Assignee: EUROCOPTER, Marignane Cedex (FR)

(21) Appl. No.: 13/050,242

(22) Filed: Mar. 17, 2011

(30) Foreign Application Priority Data
Mar. 23, 2010 (FR) 10 01141

(51) Int. Cl. B64C 27/615

(52) U.S. Cl. 416/23

(57) ABSTRACT

A blade (10) of a rotary wing (3), the blade being rigid in twisting and extending from a root (11) to a free end (12), said blade (10) including at least one swept-back segment (23). The blade (10) includes movable twist means (30) fastened to the swept-back segment (23), said blade (10) having actuator means (40) for twisting the blade (10) by varying the angular position of said twist means (30) relative to said swept-back segment (23).

### CROSS REFERENCE TO RELATED APPLICATIONS

This application claims the benefit of FR 10/01141 filed on Mar. 23, 2010, the disclosure of which is incorporated in its entirety by reference herein.

### BACKGROUND OF THE INVENTION

(1) Field of the Invention

The present invention relates to a rotary wing blade including a swept-back segment, to a rotary wing including such a blade, and to an aircraft including such a rotary wing.

(2) Description of Related Art

A rotary wing of a rotorcraft must naturally posses aerodynamic performance suitable for providing the rotorcraft with lift, and possibly also with propulsion when the rotorcraft is a helicopter, for example. Furthermore, the rotary wing must satisfy requirements that are constricting relating to acoustic certification standards. As a result, the shape of a blade may be defined while taking both of these two aspects into account, which aspects can sometimes be found to be contradictory.

Document EP 1 557 354 describes a rotary wing blade that is optimized from an acoustic point of view.

That blade presents a swept-back segment.

It should be recalled that starting from the end of the blade that is closest to its root and going towards the free end of the blade, a segment that is swept back is a segment that is directed in a direction opposite from the advance direction of the blade so as to form a negative angle relative to the radial direction of the blade. Conversely, a swept-forward segment is directed in the advance direction of the blade so as to form a positive angle with a radial direction of the blade. It should be observed that the person skilled in the art is fully aware of the vocabulary concerning swept forward and swept back.

More precisely, according to document EP 1 557 354, the blade comprises in succession, starting from its root: a straight radial segment, a swept-forward segment, and a swept-back segment.

Such a blade presents optimized acoustic characteristics.

Nevertheless, it may be observed that such a blade presenting in particular a swept-back segment is rigid in twisting and that a blade that is rigid in twisting possesses a first deformation mode in twisting that is high.

A blade is said to be rigid in twisting when its first twisting mode is situated above a given frequency. For example, a blade is said to be rigid in twisting when said given frequency is more than four times greater than the nominal speed of rotation of the rotor for a hinged rotor.

Such rigidity guarantees good dynamic behavior of the blade and enables it to be controlled in pitch. Nevertheless, such rigidity is restricting if it is desired to twist the blade actively.

It should be recalled that a blade extends longitudinally from a first end that is to be fastened to a rotary hub of a rotor, towards a second end that is referred to as its “free” end. Relative to the rotor, it can be understood that the blade extends radially from its first end towards its second end. Furthermore, the blade extends transversely from a leading edge towards a trailing edge. The blade includes in particular an outer covering having a first skin on its suction side, referred to for convenience as its “suction-side skin”, and a second skin on its pressure side, referred to for convenience as its “pressure-side skin”.

Such a blade of a main lift rotor of a rotorcraft develops lift during the rotary movement of said main rotor that serves to provide the rotorcraft with lift, and possibly also propulsion. Depending on the pitch angle of the blade, it develops more or less lift. The aerodynamic angle of incidence of each aerodynamic profile of the blade, referred to simply as its “profile” for convenience, on a section normal to the axis about which the pitch of the blade is varied depends on the pitch angle of the blade.

In contrast, for a given profile, and thus for a given section of the blade, starting from a threshold angle of incidence, it is observed that the air streamlines at the leading edge or behind the leading edge and going towards the trailing edge of said profile become separated. Such separation leads to the blade stalling, i.e. to a sudden drop of its lift should that phenomenon propagate and occupy a zone between two profiles that defines a critical area along the span of the blade. Furthermore, streamline separation gives rise to turbulence that increases the drag coefficient of the blade and increase vibration.

In order to limit separation, one solution consists in twisting the blade geometrically. It should be observed that the geometrical twisting of a blade may be defined by the angle formed between the chord of each profile of a blade section and a reference plane for the blade. Sometimes, each blade profile is twisted relative to the pitch variation axis of the blade through an angle identified relative to such a reference plane.

For a given blade trajectory, it can be understood that twisting has a direct influence on the aerodynamic angle of incidence of each profile. Under such conditions, the term “twisting relationship” is used to designate how said twist angles vary along the span of the blade.

The twisting relationship of a blade is unchanging by construction. The twisting relationship is the result of a compromise that is accepted to satisfy optimum operation of the rotor over the entire flight domain.

It is found that a small twisting amplitude over the entire span of the blade, i.e. a small difference between the extreme twist angles, serves to minimize the power consumed by the rotor for providing a rotorcraft with lift in forward flight. Conversely, a large twist amplitude over the entire span of the blade serves to minimize power consumption by the lift rotor of a rotorcraft in hovering flight, but is unacceptable during forward flight. It should be observed that the term “small” amplitude is used to mean an amplitude of less than 6°, for example, whereas the term “large” amplitude is used to mean an amplitude greater than 20°, for example.

Thus, a twist amplitude lying between those small and large amplitudes represents a compromise, in terms of power consumption, between a stage of forward flight and a stage of hovering flight.

In order to avoid such a compromise, proposals have been made to control the twisting of a blade by using dedicated means, at least locally.

In one solution, at least one flap is used that locally extends the trailing edge of the blade. By modifying the angle of said flap relative to the blade, the local geometry of the blade is modified as are the aerodynamic characteristics of the corresponding profiles.

This solution presents the advantage of generating local deformation and twisting. The following publications relate to actuating such flaps:
O. Dieterich, B. Enenkl, D. Roth: Trailing edge flaps for active rotor control, Aeroelastic characteristics of the ADASYS rotor system, American Helicopter Society, 62^{nd} Annual Forum, Phoenix, Ariz., May 9-11, 2006.
S. R. Hall and E. F. Prechtl: Preliminary testing of a Mach-scaled active rotor blade with a trailing edge servo-flap, Massachusetts Institute of Technology 77 Massachusetts Ave. Cambridge, Mass. 02139-4307 USA, 2000.
V. Giurgiutiu: Active-materials induced-strain actuation for aeroelastic vibration control, The Shock and Vibration Digest, Vol. 32, No. 5, September 2000, 355-368.
F. K. Straub, D. K. Kennedy, D. B. Domzalski, A. A. Hassan, H. Ngo, V. Anand, and T. Birchette: Smart material-actuated rotor technology, Journal of Intelligent Material Systems and Structures, Vol. 15 Apr. 2004.
C. K. Maucher, B. A. Grohmann, P. Jänker, A. Altmikus, F. Jensen, H. Baier: Actuator design for the active trailing edge of a helicopter rotor blade.
K. Thanasis: Smart rotor blades and rotor control for wind turbines, State of the Art, UpWind internal report for WP 1B3, December 2006.
Similarly, documents U.S. Pat. No. 7,424,988, US 2008/0237395, U.S. Pat. No. 6,513,762, U.S. Pat. No. 5,387,083, U.S. Pat. No. 6,135,713, U.S. Pat. No. 5,626,312 mention the presence of flaps.

However, the flaps appear to be placed on basic blades, and not on blades that are rigid in twisting and provided with a swept-back segment. The flaps are arranged on blades that are flexible in twisting in order to be able to “twist” the blade dynamically and to seek to reduce noise and vibration from the rotor. By definition it appears to be difficult a priori to twist a blade that is rigid in twisting, or at least to do so without penalizing the aerodynamic performance of the blade.

Furthermore, it should be observed that document GB 2 298 624 presents a blade using a flap to modify the pitch of the blade as opposed to seeking to twist the blade.

The state of the art further includes the following documents: GB 2 280 412, US 2005/158175, U.S. Pat. No. 5,505,589, WO 2008/002809, and U.S. Pat. No. 2,455,866.

### SUMMARY OF THE INVENTION

The present invention thus provides a blade that is rigid in twisting and that makes little noise, presenting dynamic behavior that is good, aerodynamic performance that is improved, and means for modifying twisting, referred to as “twist means” for convenience, in order to satisfy the requirements for the various flight configurations of a rotorcraft.

According to the invention, a blade of a rotary wing that performs rotation at a nominal frequency is rigid in twisting and extends from a root to a free end, the blade including at least one swept-back segment, and the root of the blade being connected to a pitch rod for the blade.

It is recalled that a rotary wing rotates at a given nominal speed that is conventionally expressed in revolutions per minute, the nominal frequency being expressed in hertz and being equal to the number of revolutions performed by the rotary wing in one second at the nominal speed.

Under such circumstances, the blade has a first twisting deformation mode that occurs at a twisting frequency that is more than four times greater than said nominal frequency of the rotary wing that is to include said blade.

Reference may be made to the literature to obtain additional information relating to blades that are rigid in twisting.

Furthermore, the blade is remarkable in particular in that it includes movable twist means fastened to the swept-back segment, the blade having actuator means for actuating twisting of the blade to vary the angular position of the twist means relative to the swept-back segment.

Under such circumstances, the actuator means enable the movable twist means to be moved relative to the body of the swept-back segment. By modifying the angle of incidence of the twist means relative to the body of the swept-back segment and relative to the remainder of the blade, a force is generated locally at the twist means.

Since the front portion of the blade is represented by the leading edge of the blade, and since the swept-back segment of the blade is directed rearwards, the twist means is offset towards the rear of the blade. By generating a relatively small force using the twist means at the trailing edge of the swept-back segment, a twisting moment is nevertheless obtained that is sufficient to modify the twisting of the blade by a few degrees, between the point where the force is applied, i.e. at the twist means, and the root of the blade, by virtue of a good lever arm. It then becomes possible to twist the blade actively even though it is rigid in twisting.

It should be observed that the deformation is entirely reversible and adjustable. It suffices to modify the angle of incidence of the movable twist means relative to the swept-back segment in order to obtain the desired deformation.

The twist means do not modify the pitch of the blade but they do serve to twist a blade that appeared to be impossible to twist because of its rigidity in twisting.

The blade may include additional characteristics.

Thus, the twist means generate lift, each profile of the blade having a twist center, the lift being offset along a chord relative to an alignment of the twist centers, i.e. a direction presenting an angle relative to the pitch variation axis of the blade.

Under such circumstances, the offset along the chord of the twist means generates a lift lever arm relative to said alignment of the twisting centers. This creates a twisting moment that is suitable for twisting the blade, at least in part.

According to another aspect, the movable twist means comprise at least one hinged flap. The flap of the twist means then has the function of twisting the blade and not of changing the pitch of the blade.

The flap may then be hinged to the trailing edge of said swept-back segment.

Furthermore, starting from the root of the blade, the blade comprises in succession a straight radial segment, a swept-forward segment, and then said swept-back segment.

The blade may also include at least one of the characteristics of the blade described in document EP 1 557 354.

Furthermore, the blade extends from a first end segment at the root towards a second end segment at the free end, the swept-back segment constituting the second end segment.

By maximizing the distance between the root of the blade and the twist means, it is possible to obtain twisting over the entire span of the blade.

It should be observed that the result of the twisting depends on the stiffness of the blade in twisting. Its amplitude may vary locally as a function of said stiffness.

Furthermore, the actuator means may possess a memory containing twisting relationships as a function of various parameters, e.g. as a function of the forward speed of the aircraft.

In another variant, the blade includes control means connected to the actuator means, the control means being remote from the blade so as to be activatable by an operator. For example, the control means may be arranged in the cockpit of the aircraft having the blade, with the pilot of the aircraft then being in a position to modifying the twisting of the blade by using the control means.

In accordance with another aspect of the invention, the actuator means comprise means for actuating the twist means over a small amplitude, an amplitude of substantially less than 15 degrees. Thus, the deformation that is obtained is “static” as opposed to frequency deformation of the type used for varying the pitch of the blade.

In addition to a blade, the invention provides a rotary wing performing rotation at a nominal frequency and provided with a blade of the invention as described above.

Furthermore, the blade has a first mode of deformation in twisting that occurs at a twisting frequency that is more than four times greater than said nominal frequency of the rotary wing.

Finally, the invention provides a rotary wing aircraft having a rotary wing of the invention that performs rotation at a nominal frequency.

### BRIEF DESCRIPTION OF THE DRAWINGS

The invention and its advantages appear in greater detail from the following description of embodiments given by way of illustration with reference to the accompanying figures, in which:

FIG. 1 is a view of a blade constituting a first embodiment;

FIG. 2 is a view of a blade constituting a second embodiment; and

FIG. 3 shows an aircraft provided with a blade of the first embodiment.

### DETAILED DESCRIPTION OF THE PREFERRED EMBODIMENT

Elements that are present in more than one of the figures are given the same references in each of them.

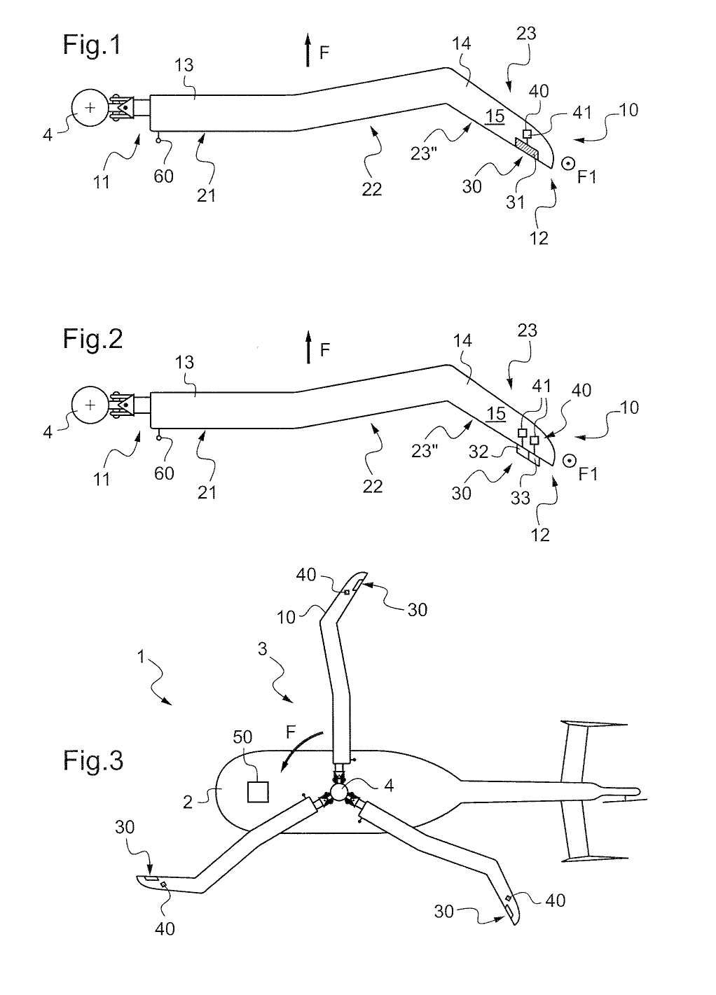

FIG. 1 shows a blade 10 constituting a first embodiment.

Whatever the embodiment, the blade 10 extends from a root 11 fastened to a hub 4 of a rotary wing, out towards a free end 12.

Furthermore, the blade 10 is provided with a swept-back segment 23. As in the example shown in the figures, the blade 10 may comprise in succession, starting from its root 11: a radial segment 21 that is straight, a segment 22 that is swept forward, followed by a segment 23 that is swept back.

It is recalled that a swept-forward segment presents a positive angle in the direction of advance F of the blade 10 relative to a straight radial segment, whereas a swept-back segment presents a negative angle in the advance direction F, these notions of swept-forward and swept-back being explained in the literature.

Furthermore, the root 11 of the blade includes a pitch rod 60, the pitch rod 60 being connected by a hinge to the root of the blade in order to modify the pitch of the blade 10.

Furthermore, the blade 10 is provided with a controllable twist system suitable for modifying the twist of the blade, in particular while the blade is rotating about the axis of rotation of the hub 4. The controllable twist system therefore does not have the function of changing the pitch of the blade 10, since pitch control is performed by the pitch rod 60.

The twist system comprises movable twist means 30 fastened to the swept-back segment 23. For example, the twist means 30 may be provided with at least one flap hinged to the trailing edge 23″ of the swept-back segment 23.

In the first embodiment shown in FIG. 1, the flap 31 of the twist means 30 is streamlined and incorporated in the aerodynamic profile of the swept-back segment 23.

In the second embodiment shown in FIG. 2, the flap 32, 33 projects locally from the swept-back segment 23, and extends therefrom.

Independently of the embodiment, it should be observed that the twist means 30 may comprise a flap 31 as in the example of FIG. 1, or a plurality of flaps 32, 33, as shown in FIG. 2.

Furthermore, the blade includes actuator means 40 for controlling the twist means 30. For example, the actuator means may comprise a rotary motor suitable for causing the twist means to rotate about an axis whereby it is fastened to the swept-back segment 23. The actuator means 40 may be arranged inside the blade, and in particular inside the swept-back segment 23.

Optionally, and with reference to FIG. 2, the actuator means may possess a plurality of units, e.g. one motor 41 per flap. It can be understood that any other movement means may be used.

Thus, the actuator means may require the twist means to turn relative to the swept-back segment 23. Such turning generates vertical forces in the direction F1. However, the rearward offset of the blade at the twist means gives rise to a twisting moment generated by said vertical forces relative to the twist axis. The blade 10 then tends to twist progressively between its root 11 and the twist means.

The rearward offset along the chord of the twist means magnifies the force via a lever arm effect relative to the alignment of the twist centers of the portions inside the rotor diameter that follow a shape that is fairly rectilinear.

Furthermore, by having the twist means 30 as far away as possible from the root 11, it is possible to twist a maximum fraction of the blade 10.

In addition, it can be understood that the twisting moment is also maximized. A small amount of pivoting of the twist means 30 therefore generates a large amount of twisting of the blade 10.

Consequently, starting from the root 11 and going towards the free end 12, the blade extends from a first end segment 13 towards a second end segment 14. The swept-back segment 23 optionally constitutes the second end segment 14.

Optionally, in order to limit noise emission, the function of the actuator means is to actuate the twist means 30 over a small amplitude that is substantially less than 15 degrees.

Furthermore, the deformation of the blade is controlled as a function of the flight configuration so as to obtain deformation that is static throughout the duration of a given stage of flight.

FIG. 3 shows an aircraft 1 having a rotary wing 3, the aircraft that is shown diagrammatically being a helicopter.

Said rotary wing includes a hub 4 to which a plurality of blades 10 are fastened, e.g. three blades.

The actuator means 40 for each blade 10 may include actuation relationships for the twist means 30 so as to modify the twisting of the blade as a function of the stage of flight, for example.

In the alternative variant shown diagrammatically, each blade 10 has control means 50 that are remote and that are possibly arranged in the cockpit 5 of the aircraft 1. Like the variant shown diagrammatically, at least two distinct blades may share control means in common.

The control means are connected to each of the actuator means by a wired or wireless connection.

Using the control means 50, the pilot of the aircraft can then modify the twist of each blade 10 manually.

The control means may also serve to set into operation an automatic twisting mode.

Naturally, the present invention may be subjected to numerous variants as to its implementation. Although several embodiments are described, it will readily be understood that it is not conceivable to identify exhaustively all possible embodiments. It is naturally possible to envisage replacing any of the means described by equivalent means without going beyond the ambit of the present invention.

For example, the swept-forward segment and the straight radial segment are optional, or they may be positioned in some other manner relative to the swept-back segment.

What is claimed is:

1. A blade of a rotary wing that rotates at a nominal frequency, said blade being rigid in twisting and extending from a root towards a free end, said blade including at least one swept-back segment, said blade root being connected to a pitch rod, wherein the blade includes movable twist means fastened to the swept-back segment, said blade having actuator means for actuating twisting of the blade to vary the angular position of said twist means relative to said swept-back segment.

2. A blade according to claim 1, wherein said twist means generate lift, each profile of said blade having a twist center, said lift being offset along a chord relative to an alignment of said twist centers.

3. A blade according to claim 1, wherein said movable twist means comprise at least one hinged flap.

4. A blade according to claim 3, wherein said flap is hinged to the trailing edge of said swept-back segment.

5. A blade according to claim 1, wherein starting from the root of the blade, the blade comprises in succession a straight radial segment, a swept-forward segment, and then said swept-back segment.

6. A blade according to claim 1, wherein the blade extends from a first end segment at said root towards a second end segment at said free end, said swept-back segment constituting said second end segment.

7. A blade according to claim 1, wherein the blade includes control means connected to the actuator means, said control means being remote from the blade so as to be activatable by an operator.

8. A blade according to claim 1, wherein said actuator means actuate said twist means over a small amplitude of less than 15 degrees.

9. A rotary wing performing rotation at a nominal frequency, wherein the wing includes at least one blade according to claim 1.

10. A rotary wing according to claim 9, wherein said blade has a first twisting deformation mode that occurs at a twisting frequency higher than four times said nominal frequency of the rotary wing.

11. An aircraft, including a rotary wing according to claim 9.
